(19) United States
(12) Patent Application Publication
(10) Pub. No.: US 2012/0313751 A1
(43) Pub. Date: Dec. 13, 2012

(54) SYSTEM AND METHOD FOR INDIVIDUALLY PROVIDING A FUNCTION TO A USER

(76) Inventors: Michael Kaelbling, Munchen (DE); Reiner Muller, Peiting (DE)

(21) Appl. No.: 13/575,945

(22) PCT Filed: Dec. 28, 2010
(86) PCT No.: PCT/EP10/70779

§ 371 Date: Jul. 30, 2012

(30) Foreign Application Priority Data
Jan. 27, 2010 (DE) 10 2010 005 883.1

(51) Int. Cl. G06F 7/04

(52) U.S. Cl. 340/5.61

(57) ABSTRACT

A system and method are provided for user-specific provision of at least one function to a user that has a mobile unit storing user data of the user, wherein the user data is transmitted via a background system to a controllable device that provides the functions to the particular user individually according to the transmitted user data of the user. The device may be suitable for a wide variety of application areas, in particular for vehicle units, production devices, media playback devices and devices that are made available to the user by a third party, for example, a rental car agency. The functions can be provided in a manner familiar to the user by a device made available to the user by a third party.

### CROSS-REFERENCE TO RELATED APPLICATIONS

This application is a U.S. National Stage Application of International Application No. PCT/EP2010/070779 filed Dec. 28, 2010, which designates the United States of America, and claims priority to DE Patent Application No. 10 2010 005 883.1 filed Jan. 27, 2010. The contents of which are hereby incorporated by reference in their entirety.

### TECHNICAL FIELD

The disclosure relates to an apparatus and a method for individually providing at least one function to a user, whereby this may be a person, an animal or a moveable machine.

### BACKGROUND

Devices, which may be in different environments, usually have to be manually configured in a time-consuming fashion for instance in a motor vehicle or in a living space in order to configure them so as to be familiar to a specific user, for instance for operation of the respective device. With some conventional devices, it is possible to correspondingly store user settings and/or user-individual configurations. These user-individual configurations can then be used automatically if necessary to adjust the device. Vehicle seats are for instance sometimes used in vehicles, wherein seat settings of a user are read out onto a memory in order to adjust the motor vehicle seat. This user data is stored in a user's car key for instance and is if necessary automatically read out and transferred to the driver's seat for adjustment purposes. A user and/or driver can sit in his/her vehicle and adjust his/her driver's seat according to requirements. The adjusted user data is then stored in the user's car key. If a married couple has a shared vehicle for instance and each spouse has his/her own car key, an automatic adjustment of the car seat can in this way be implemented in each instance separately for the husband and/or wife, after they have inserted their respective car key into the vehicle door lock or into the vehicle control console. Similarly, mirror adjustments can also be performed automatically. However, this conventional system is not suited for instance to rental cars. In this way a user receives a car key from a rental car company for the rented vehicle, without a user-individual setting being able to take place automatically in the rented vehicle, for instance of the driver seat or mirrors for the user.

### SUMMARY

In one embodiment, an apparatus is provided for individually providing at least one function to a user, who has a mobile unit, which stores user data of the user, wherein the user data is transmitted via a background system to a controllable device, which provides the functions to the respective user individually as a function of the transmitted user data of the user.

In a further embodiment, the mobile unit is carried by the user, is attached to the user, is implanted in the user, or is integrated in the user. In a further embodiment, the mobile unit has a volatile or non-volatile data memory for storing the user data and a transceiver for reading out the user data via an interface of the mobile unit by means of the background system. In a further embodiment, the user data can only be read out from the mobile unit after unique identification of the user, wherein the identification takes place by means of a user identification unit, which is connected to the controllable device or to the background system. In a further embodiment, the user identification unit identifies the respective user with the aid of a user entry, with the aid of the user behavior, or with the aid of a feature of the user. In a further embodiment, the mobile unit carried by the user is a mobile telephone, a PDA, a laptop, an RFID tag or an electronic key. In a further embodiment, the background system identifies a current location of the user and transmits the same to the controllable device together with the user data. In a further embodiment, the controllable device compares its position with the location of the user and provides the functions according to the user data if the user is in the vicinity of the device. In a further embodiment, a previous or a future movement profile of the user is determined from the locations of the user. In a further embodiment, the user data comprises user status data of the user, in particular personal user data, and functional target data which can be adjusted by the user with respect to the functions provided by the device to the user.

In a further embodiment, the device adjusts the respective function individually as a function of the user data of the user transmitted by the background system and as a function of the environmental conditions detected using sensors, by a determined movement profile of the user and by an operating state of the device. In a further embodiment, the device provides a function to a user, which is a person, an animal or a moveable machine. In a further embodiment, the controllable device, is a media playback device, an adjustable vehicle unit, an adjustable terminal, in particular an adjustable telephone device or an adjustable computer device, or a manufacturing device of a production plant.

In another embodiment, a vehicle includes an apparatus according to any of the embodiments disclosed above, wherein a controllable vehicle unit of the vehicle can be automatically individually adjusted to a user as a function of the user data.

In another embodiment, a media playback device includes an apparatus according to any of the embodiments disclosed above, wherein the media playback device individually plays back media contents, in particular audio or video sequences, as a function of the user data transmitted for the user by the background system to the media playback device. In a further embodiment, the user data has media content target data of the user, which is compared with available media contents, which are provided by at least one content provider on different media transmission channels, and wherein the media contents are selected as a function of the media content target data for playback purposes.

In another embodiment, a manufacturing device includes an apparatus according to any of the embodiments disclosed above, wherein the manufacturing device informs a user of a necessary maintenance measure in the event of a maintenance requirement or in the event of a fault incident, if the user data of the user transmitted to the manufacturing device specifies that this user is able to implement the necessary maintenance measures.

In another embodiment, a method provides at least one user-individual function to a user, the user data of which is transmitted via a background system to at least one device, which automatically provides the function to the respective user individually as a function of the transmitted user data. In a further embodiment, the user data includes user status data of the user, in particular personal user data, and functional target data which can be adjusted by the user with respect to the functions provided by the device to the user. In a further embodiment, the user-individual function provides the device in a manner suited to the user, which is specified in the function target data.

### BRIEF DESCRIPTION OF THE DRAWINGS

Example embodiments will be explained in more detail below with reference to figures, in which:

FIG. 1 shows a block diagram of one embodiment of the apparatus disclosed herein,

FIG. 2 shows a block diagram of a further embodiment of the apparatus disclosed herein,

FIG. 3 shows a block diagram of a further embodiment of the apparatus disclosed herein,

FIG. 4 shows a block diagram of a further embodiment of the apparatus disclosed herein,

FIG. 5 shows a block diagram of a further embodiment of the apparatus disclosed herein,

FIG. 6 shows a block diagram of a further embodiment of the apparatus disclosed herein,

FIG. 7 shows a block diagram of a further embodiment of the apparatus disclosed herein.

### DETAILED DESCRIPTION

Some embodiments provide an apparatus and a method for individually providing at least one function to a user on or through a device, which is provided to the user by means of a third-party.

For example, some embodiments provide an apparatus for individually providing at least one function to a user, which has a mobile unit, which stores user data of the user, wherein the user data is transmitted to a controllable device via a background system, said device providing the functions to the respective user individually as a function of the transmitted user data of the user.

In one embodiment, the mobile unit is carried along by the user, for instance a person.

In a further embodiment, the mobile unit is attached to the user, for instance farm animal.

In a further embodiment, the mobile unit is implanted in the user, for instance in the form of a chip.

In one further embodiment, the mobile unit is integrated in the user, for instance in a moveable machine.

In one embodiment, the mobile unit comprises a volatile or non-volatile data memory for storing the user data and a transceiver for reading out the user data by way of an interface of the mobile unit by means of the background system.

The user data may be read out wirelessly from the data memory of the mobile unit by means of a reading unit or a base station of the background system.

In one embodiment, the user data is initially read out from the mobile unit after unique identification of the user.

This identification may take place by means of a user identification unit, which is connected to the controllable device or to the background system.

In one embodiment, the user identification unit identifies the user with the aid of a user entry, for instance with the aid of a pin number entry or a password entry.

In a further embodiment, the user identification unit identifies the respective user with the aid of a behavior of the user, for instance kinesic behavior of the user.

In a further embodiment, the user identification unit identifies the respective user with the aid of a feature of the user, for instance with the aid of at least one body feature.

In one embodiment, the mobile unit carried by the user is a mobile telephone, a PDA, a laptop, an RFID tag or an electronic key.

In one embodiment, the background system identifies a current location of the user and transmits information about this location to the controllable device together with the user data.

In one embodiment, the controllable device compares its position with the location of the user and individually provides at least one function corresponding to the user data, if the user is in the vicinity of the device.

In one embodiment, a previous and a future movement profile of the user is determined from the identified locations of the user.

In one embodiment, the user data comprises user status data of the user, in particular personal user data, and functional target data which can be set by the user with respect to the functions provided by the device to the user.

In one embodiment, the device adjusts the respective functions individually as a function of the user data of the user transmitted by the background system and as a function of the ambient conditions detected using sensors, a determined movement profile of the user as well as an operating state of the device.

In one embodiment, the controllable device is a media playback device.

In a further embodiment, the controllable device is an adjustable vehicle unit.

In a further embodiment, the controllable device is an adjustable terminal, in particular a telephone device or a computer.

In a further embodiment, the controllable device is a manufacturing device or a production device.

Some embodiments provide a vehicle having an apparatus for individually providing at least one function to a driver or passenger, wherein the driver or passenger has a mobile unit, which stores the user data of the driver or passenger, wherein the user data is transmitted via a background system to a controllable vehicle unit, which provides the functions to the respective driver or passenger individually as a function of the transmitted user data of the driver and/or passenger.

The vehicle unit may be a vehicle seat or a vehicle mirror for instance.

Other embodiments provide a media playback device with an apparatus for individually providing at least one function to a user, which has a mobile unit, which stores the user data of the user, wherein the user data is transmitted via a background system to the controllable media playback device, which provides the functions to the respective user individually as a function of the transmitted user data of the user.

The media playback device plays for instance media contents, e.g., audio or video sequences, as a function of the user data to the user which is transmitted via the background system to the media playback device.

In one embodiment of the media playback device, the user data received from the background system by the media playback device comprises media content target data of the user, which is compared with available media content data, which is provided by at least one content provider on one or several transmission channels, wherein the media content data is selected as a function of the media content target data of the user for playback purposes.

Other embodiments provide a manufacturing device having an apparatus for individually providing at least one function to a user, for instance to a maintenance technician, who has a mobile unit, which stores user data of the user, wherein the stored user data is transmitted via a background system to the controllable manufacturing device, which provides the functions to the respective user individually as a function of the transmitted user data of the user.

The function may comprise outputting a notification of a necessary maintenance measure.

In the event of a need for maintenance or in the event of a fault, the manufacturing device in this case notifies the user, in other words the maintenance technician, of a necessary maintenance measure, if the user data of the user transmitted to the manufacturing device is specified and/or displayed, such that the respective user is able to implement this necessary maintenance measure.

Other embodiments provide a method for providing at least one user-individual function to a user, the user data of which is transmitted via a background system to a device, which provides the functions to the respective user individually as a function of the transmitted user data.

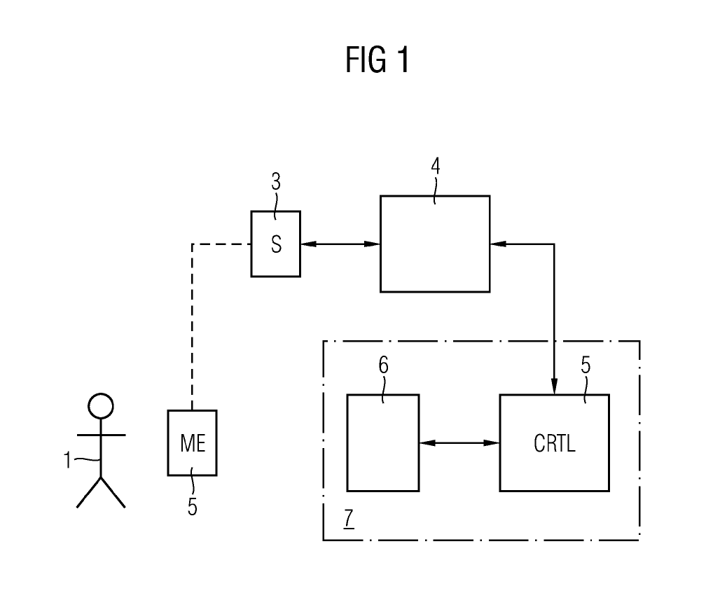

As apparent from FIG. 1, in the exemplary embodiment shown, a user 1 has a mobile unit 2, which can store the user data of the user 1. The user data is stored for instance in a data memory of the mobile unit 2. In the exemplary embodiment shown, the mobile unit 2 is carried by the user 1. In the exemplary embodiment shown in FIG. 1, the user 1 is for instance a person, who carries the mobile unit 2 on him/herself. This mobile unit 2 is a mobile telephone for instance. Alternatively, the mobile unit 2 can also be a laptop, a PDA, an RFID tag or an electronic key. The user data stored in the mobile unit 2 is read out by a background system and/or backend system 4 by way of an interface 3 if required or on request. In the example shown, this user data is transmitted to a control unit 5, which controls at least one device 6. The control unit 5 can also be integrated in the device 6. The control unit 5 and the device 6 together form a service system 7. The control unit 5 can control the device 6 and also monitor the operating state of the device 6. The device 6 provides one or more functions to the respective user 1 automatically and individually as a function of the user data received by the background system 4.

If the controllable device 6 and/or the service system 7 cannot be connected to the background system 4, in one embodiment the user data can also be transmitted via the mobile unit 2 via an interface to the device 6 and/or the service system 7. The mobile unit 2 can in this case also be used as a proxy and/or as a bridge to the background system 4.

The device 6 can be an adjustable car seat for instance. This car seat is in a rental car for instance, which the user 1 rents from a car rental company. The user data of the user 1 which is stored in the mobile unit 2, for instance a mobile telephone, is read out by the background system 4, which is for instance a mobile network, via an interface 3, for instance a base station. The read-out user data includes for instance the individual body size of the user 1. The user data is then transmitted to the control unit 5, which automatically individually adjusts the car seat 6 according to the body size of the user 1. In one possible embodiment, the adjustment only takes place once the user 1 stays locally in the vicinity of the rental car. The mobile unit 2 may contain a volatile or non-volatile data memory for storing the user data. This user data can be input by the user 1 by way of a user interface of the mobile unit 2. The mobile unit 2 also contains a transceiver for reading out the user data via the interface 3 by the background system 4.

In one embodiment, the user data of the user can only be read out from the data memory of the mobile unit 2 after unique identification of the user. In one possible embodiment, the identification takes place by a user identification unit, which is connected to the controllable device 6 and/or the service system 7. In an alternative embodiment, the identification takes place by means of a user identification unit, which is connected to the background system 4 or forms part of the background system 4.

The identification and/or authentication of the user 1 can take place in different ways. In one possible embodiment, the user identification of the user 1 takes place with the aid of an entry of the user 1, for instance by entering a password or a PIN number. In an alternative embodiment, identification and/or authentication of the user 1 takes place by means of the user identification unit with the aid of a behavior, for instance a kinesic behavior of the user 1.

In a further possible embodiment, the identification and/or authentication of the user 1 takes place with the aid of a feature, in particular a body feature of the user 1.

In one possible embodiment, the background system 4 identifies a current location of the user 1 and transmits this current location, together with the user data, to the controller 5 of the controllable device 6. In one possible embodiment, the controllable device 6 compares its position and/or location with the current location of the user 1 and provides the corresponding functions as a function of the user data, if the user 1 stays and/or is in the vicinity of the device 6.

In one possible embodiment, a previous movement profile and if necessary also a future movement profile of the user 1 is determined and/or calculated from the locations of the user 1. Calculation of the movement profile can take place for instance by means of the control unit 5.

The user data stored in the mobile unit 2 includes user status data of the user 1 on the one hand, in particular personal user data such as age, body size etc. as functional target data which can be adjusted by the user 1 in respect of the functions to be provided to the user 1 by the device 6. The functional target data is for instance parameter settings for control elements of the device 6.

In one embodiment, the device 6 adjusts the respective functions individually to the user automatically as a function of the user data of the user 1 transmitted by the background system 4 and as a function of further data. This further data provides for instance environmental conditions of the environment of the user 1 which are detected using sensors for instance. These environmental conditions are detected for instance by means of sensors, which are connected to the service system 7. Furthermore, the functions can be provided by the device 6 as a function of the determined movement profile of the user 1. In one further possible embodiment, the adjustment and/or provision of the functions also takes place as a function of a determined operating state of the controllable device 6.

The device 6 can be any controllable device, in particular a media playback device, an adjustable vehicle unit, an adjustable terminal, for instance a telephone or a computer, as well as a manufacturing device for a production plant. In one possible embodiment, the control unit 5 is connected to the background system 4 via a network. This network can be a wired or a wireless network. The background system 4 may detect a current location and/or a current position of the user 1.

In one embodiment, the background system 4 is connected to a navigation system and receives data relating to the environment of the user 1 and of the service system 7, which can be made available to the control unit 5. If the user has made adjustments by way of a user interface for instance, so that the two headlights of his/her vehicle are only to illuminate/shine in a tunnel, when reaching a tunnel, the control facility 5 activates the controllable headlights as devices 6 and deactivates the same when leaving the tunnel. The reaching and leaving of the tunnel can be identified for instance with the aid of navigation data, which is read out from the navigation system.

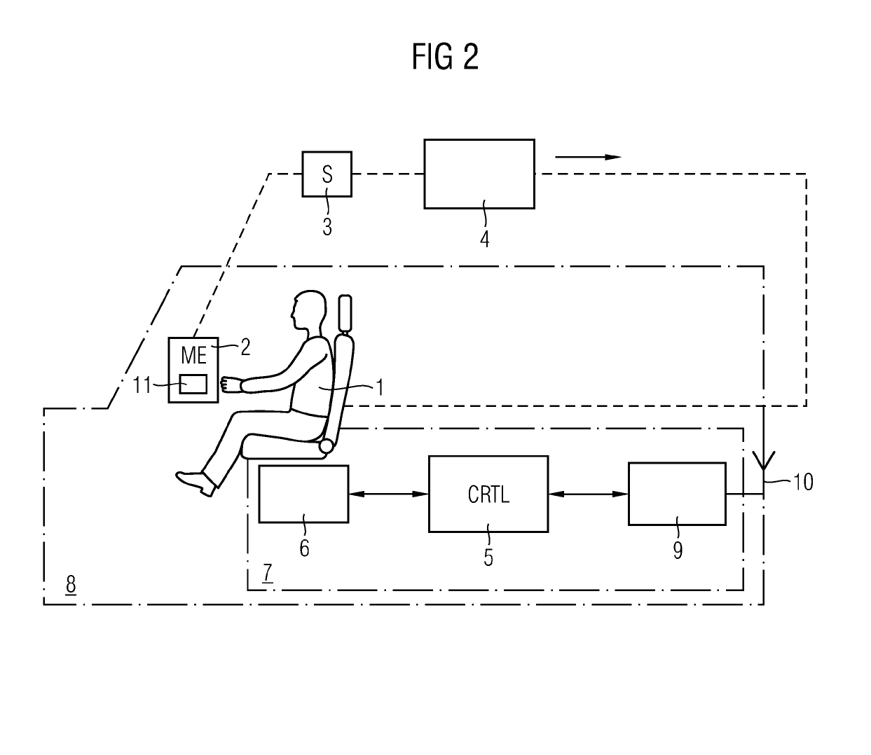

FIG. 2 shows a further example of use of the apparatus for individually providing at least one function to a user 1. In this example of use, the user sits on a controllable seat 6 of a service system 7 within a vehicle 8. The service system 7 has a control facility 5 for adjusting the car seat and also a transceiver 9, which is wirelessly connected to a backend and/or background system 4 by way of an antenna 10 and can therefore exchange data. The mobile unit 2 has a data memory 11, in which the user data of the user 1 is stored. The user data is read out by way of the interface 3 of the backend system 4 and is received by the receive antenna 10 of the transceiver 9. The user data reaches the controller 5 of the service system 7 from the transceiver 9. The physical dimensions of the user 1 are stored as user data in the data memory 11 for instance. By entering a command in a user interface of the mobile unit 2, the user 1 can trigger the transfer of user data and/or his/her body dimensions to the control unit 6 of the service system 7. This individually adjusts the seat 6 according to the body dimensions of the user. Further actuators can be actuated for instance by the control facility 5, for instance adjustable mirrors and suchlike.

The vehicle 8 may be any vehicle, for instance a passenger car or a truck. The vehicle 8 may also be a different transportation vehicle, for instance a train or an airplane. With an airplane, the backend system 4 transmits the user data via a satellite path for instance. The mobile unit 2 can also be found in a service card or an electronic ticket of a user 1.

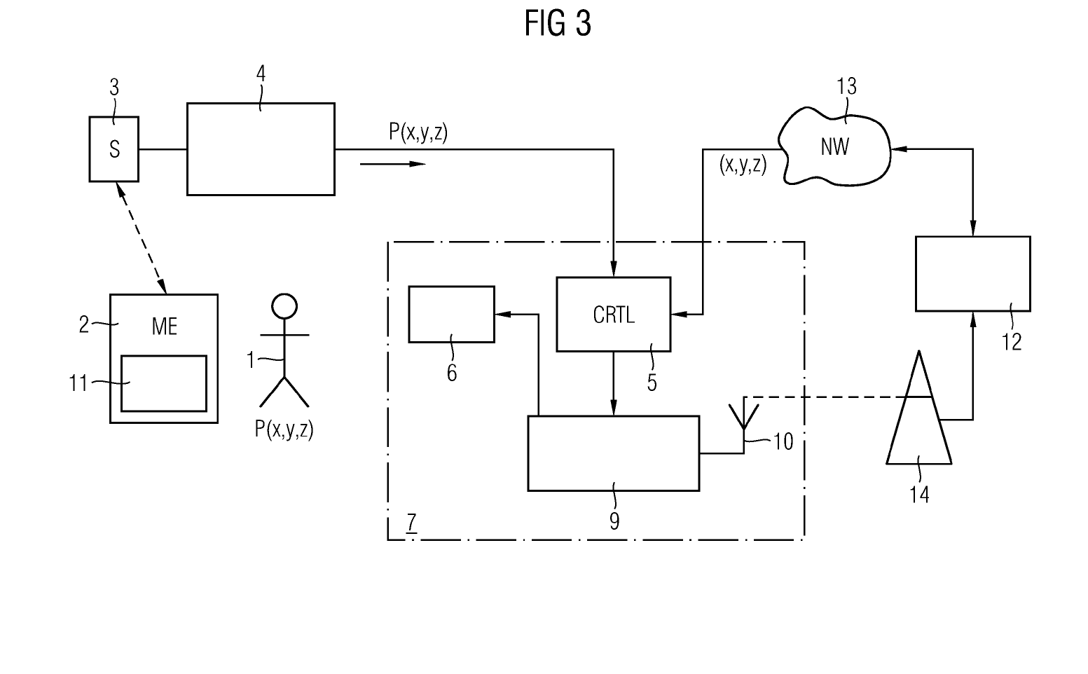

FIG. 3 shows a further example of use of the apparatus for individually providing a function to a user 1. In this exemplary embodiment, the service system 7 contains a media playback device 6, a control unit 5 and a transceiver 9. The control unit 5 controls the transceiver 9 as a function of user data, which, in the example shown, also has media content target data. The user 1, who is for instance a hotel guest, is in a hotel room in which the media playback device 6 is set up. The user 1 carries a mobile unit 2 on him/her, from the data memory of which a background system 4 reads out user data of the user 1 via the interface 3, in particular the media content target data after corresponding identification of the user. The controller 5 receives the media content target data (target content) of the user 1 and in the exemplary embodiment shown can compare this with available media contents (actual content), which are made available by at least one content provider on one or different media transmission channels. In the exemplary embodiment shown, a content provider 12 is connected to the control unit 5 of the service system 7 by way of a network 13, for instance the internet. In the exemplary embodiment shown the content provider 12 emits different television programs on different channels or frequencies by way of a transmit station 14. Furthermore, the control unit 5 can read out and evaluate a current television program from the content provider 12 by way of the network 13. The control unit 6 compares the media content target data (target content) and/or a wish list with respect to media contents of the user 1 with the television program available (actual content) of the at least one media content provider 12 and controls the transceiver 9 such that the desired program and/or media content is interconnected on the playback device 6, for instance a television. If the user 1 has set as a media content target data for instance that he/she only wishes to watch the news, in one possible embodiment, the service system 7 indicates if news is transferred onto a different program channel and thus can switch to this program. In an alternative embodiment, automatic switchover to the desired media content takes place. In this exemplary embodiment, the control unit 5 implements a matching between program wishes of the user 1 and the television program on offer. Aside from the wish list and/or media target data of the user 1, the system identifies whether the available television program on offer at the current location of the user 1 corresponds to the wishes of the user 1.

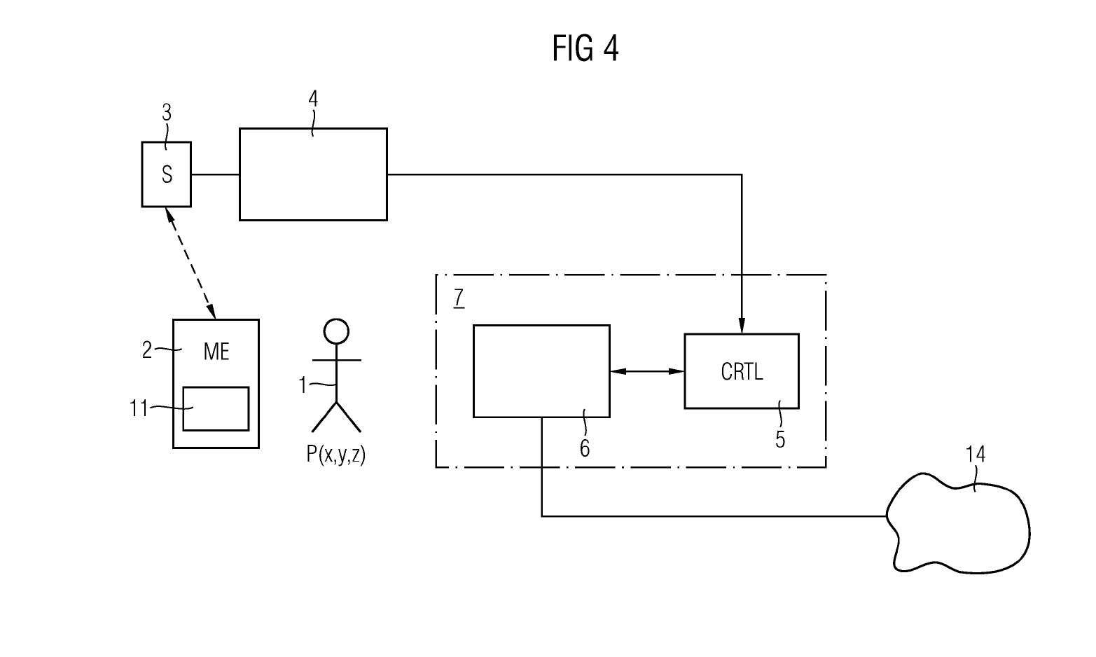

FIG. 4 shows a further example of use for the apparatus for individually providing at least one function to a user 1. In this example of application, the control data device 6 is a landline telephone device of a service system 7, which is in a hotel room of a hotel for instance. This landline telephone device 6 is connected to a fixed line telephone network 14. In this example of use, control elements of the telephone device 6 can automatically be configured in a manner such that the device 6 available in the hotel can be used in a manner known and familiar to the user 1. For instance, the mobile unit 2 can be a mobile telephone of the user 1 for instance. The short dial numbers of the user 1 which are stored in the data memory 11 of the mobile telephone 2 are automatically transmitted at the request of the user 1 via the backend system and/or background system 4 to the service system 7. The landline telephone device 6 is then automatically configured such that when entering the usual short dial number, the connection occurs with the corresponding telephone connection. For instance, if the user 1 is used to dialing a “9” in order to set up a telephone connection from a hotel number and the fixed line telephone device 6 of the hotel normally requires another digit to be dialed first, for instance “0”, at the request of the user and/or by means of an order input to the mobile unit 2 and/or into the service system 7, a corresponding reconfiguration and/or adjustment of the landline telephone device 6 can automatically take place so that the user 1 is from now on able to implement this in a conventional fashion by entering a “9” in order to set up a telephone connection outside of the hotel. Further possible examples are for instance the storage of familiar telephone numbers for specific purposes, for instance direct connect to the police or direct connect to the fire service and suchlike. Furthermore, the user 1 can store as user data that he/she would like to see “ARD” as the first television channel, and not “ORF1” even if he is in Austria and not in Germany.

The apparatus may therefore enable a person and/or user in a specific environment to provide a function in a way which is automatically individually adjusted to the wishes and habits of the user 1.

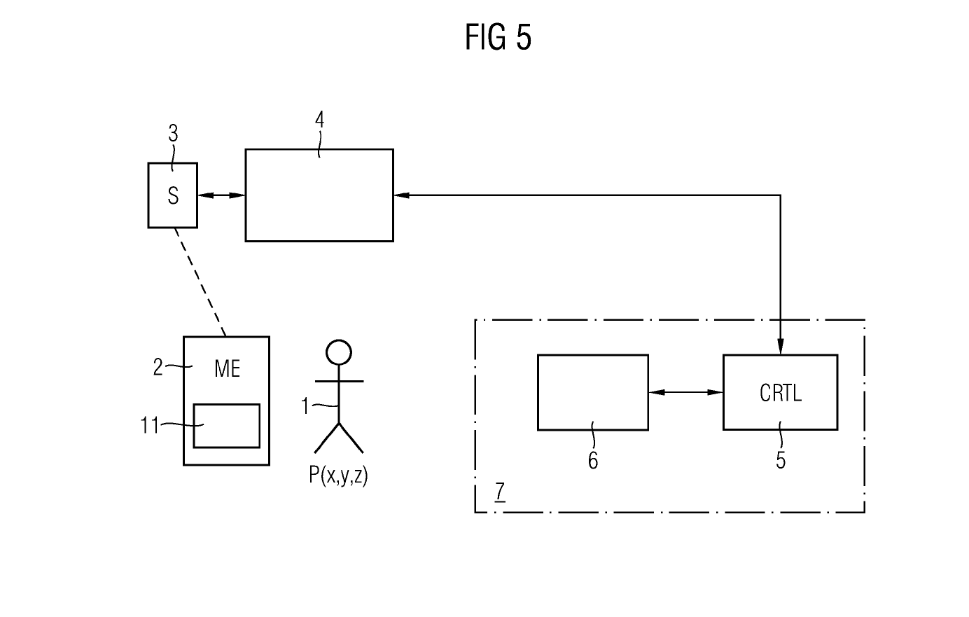

FIG. 5 shows a further example of use for the apparatus for individually providing at least one function to a user 1. In this example of use, the user 1 is for instance a maintenance technician who is in a production firm. The production firm has a production plant with a plurality of manufacturing devices 6, which can be controlled in each instance by a controller 5. The user data of the user 1 is stored in a data memory 11 of the mobile unit 2 and specifies for instance whether the user 1 is a service and/or maintenance technician. Furthermore, user data 1 can specify the abilities which the technician 1 has, for instance which devices 6 he/she can maintain and/or repair. The device 1 can be monitored using a control unit 5 with respect to its functionality. In the event of the need for maintenance or a fault incident, a necessary maintenance measure can be notified to the user 1, if the user data of the user transmitted to the controller 5 specifies that this user 1 is actually able to perform the necessary maintenance measures and/or repair measures. This can take place if the maintenance technician 1 is also spatially in the vicinity of the device 6. In one possible embodiment, the background system 4 informs the service system 7 of the presence of the service technician 1 in the vicinity of the device 1. In one possible embodiment, the service technician and/or user 1 receives a message for the necessary maintenance measures by way of an acoustic or visual display of the service system 7. Alternatively, the necessary maintenance measures can also be notified to the service technician 1 by way of his/her mobile unit 2, for instance his/her mobile telephone. This message can also specify for instance where the device 6 requiring maintenance is located.

In one embodiment, a previous movement profile of the user 1 is determined and/or calculated from the current locations of the service technician and/or user 1. This movement profile specifies for instance how the service technician 1 moves on the factory premises. A future movement profile can be calculated from the previous movement profile. For instance, a prediction can be generated therefore as to when the service technician 1 is onsite in the case of the device 6 requiring maintenance. If a prediction specifies for instance that a device and/or a system component initially has to be maintained and/or monitored, the service system 7 and/or the component to be maintained automatically informs the service technician 1 of the necessary maintenance measures and of the imminent service and/or maintenance instance. A prediction about a necessary maintenance measure in the future can be determined based on the operating state of the device 6 and on the environmental parameters which are detected using sensors for instance. The environmental temperature or the air humidity can be detected by sensors for instance as environmental parameters, and then as a function of the operational run time of the respective device 6, are supposedly forecast for imminent failures and/or fault incidents, which can be avoided by prompt maintenance measures. Storage of the environmental parameters detected using sensors can take place by means of a computer system connected to the service system 7.

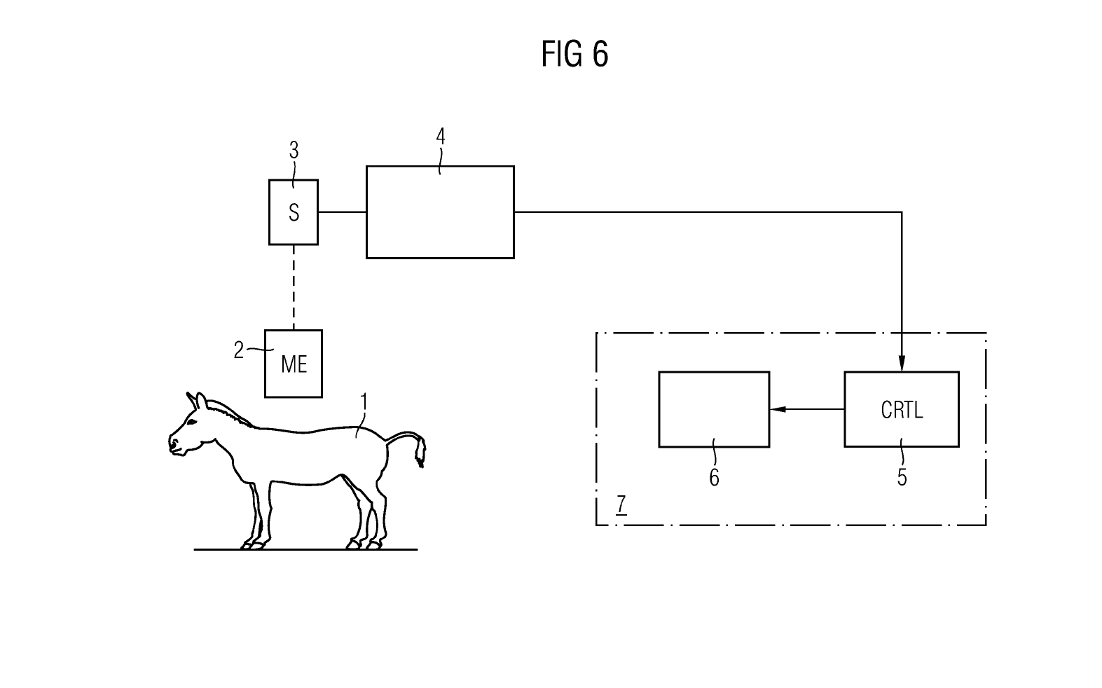

FIG. 6 shows a further example of use of the apparatus for individually providing at least one function to a user 1. In the exemplary embodiment shown in FIG. 6, the user 1 is a farm animal, for instance a cow. A mobile unit 2 can be attached to an ear of the cow, for instance a tag, which has a data memory 11 which transmits the user data relating to the cow 1 via the background system 4 to the controller 5 of the service system 7. In the example shown the service system 7 has a feeding device 6, which provides food to the cow 1. The user data specifies for instance the time intervals at which the farm animal 1 is to be fed and the quantity of food which is to be made available to the respective farm animal. For instance, the quantity of food made available can be adjusted as a function of the body weight of the cow 1.

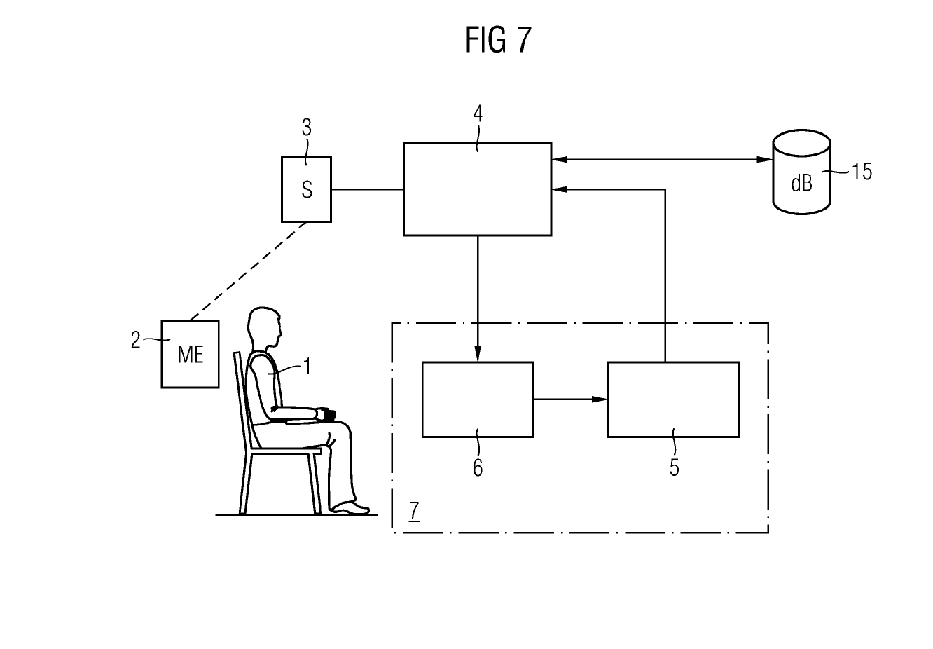

FIG. 7 shows a further example of use for the apparatus for individually providing at least one function to a user. In the exemplary embodiment shown, the user 1 is a software programmer, which has a mobile unit 2. The software programmer 1 generates a program code for the software component SK to be created by means of a computer and/or PCs. The PC 6 has an internal controller. If a specific data model and/or a code is developed and/or programmed in the software design by means of a design tool or tool for instance, a system or background system 4 running in the background in the exemplary embodiment shown in FIG. 7 compares already known data models stored in a data base 15 with the currently available data model SK-DM. If similarities of the data models are identified for instance by the background system 4, for instance on account of requirements or on account of input/output variables, in the system shown, the software designer 1 can automatically indicate this circumstance by specifying the data models coming into question.

In this way he/she has the option of reverting back to an already available data model, which is stored in the database 15, in an efficient and rapid manner.

The apparatus 1 can be used multifunctionally, as can be seen from the various examples of use. It allows for automatic adjustment of an environment discovered by the user 1 to a familiar environment of the user 1. Further application areas for the disclosed method are for instance self-organizing networks, for instance for environments for blind users and last minute bookings of any type as well as in the region of self-organizing, constantly available services.

What is claimed is:

1. A system for individually providing at least one user-specific function to a user, comprising:
a mobile unit that stores user data of the user,
a background system in communication with the mobile unit, and
a controllable device configured to:
receive the user data from the mobile unit via the background system, and
provide the at least one user-specific function to the user individually as a function of the transmitted user data of the user.

2. The system of claim 1, wherein the mobile unit is configured to be carried by the user, attached to the user, implanted in the user, or integrated in the user.

3. The system of claim 1, wherein the mobile unit comprises a volatile or non-volatile data memory for storing the user data and a transceiver for reading out the user data via an interface of the mobile unit via the background system.

4. The system of claim 3, wherein the user data is readable from the mobile unit only after unique identification of the user, and wherein the identification is provided by a user identification unit connected to the controllable device or to the background system.

5. The system of claim 4, wherein the user identification unit identifies the respective user with the aid of a user entry, user behavior data, or a feature of the user.

6. The system of claim 1, wherein the mobile unit is a mobile telephone, a PDA, a laptop, an RFID tag, or an electronic key.

7. The system of claim 1, wherein the background system is configured to identify a current location of the user and transmit the current location to the controllable device together with the user data.

8. The system of claim 7, wherein the controllable device is configured to compare a position of the controllable device with the location of the user and provide the functions according to the user data if the user is in a defined vicinity of the controllable device.

9. The system of claim 7, wherein the controllable device is configured to determine a previous or a future movement profile of the user from data identifying one or more locations of the user.

10. The system of claim 1, wherein the user data comprises user status data of the user and functional target data which can be adjusted by the user with respect to the functions provided by the controllable device to the user.

11. The system of claim 1, wherein the controllable device is configured to adjust the respective function individually as a function of the user data of the user transmitted by the background system and as a function of environmental condition data detected using one or more sensors, by a determined movement profile of the user and by an operating state of the controllable device.

12. The system of claim 1, wherein the user is a person, an animal, or a moveable machine.

13. The system of claim 1, wherein the controllable device comprises a media playback device, an adjustable vehicle unit, an adjustable terminal, or a manufacturing device of a production plant.

14. A vehicle comprising:
a system for individually providing at least one user-specific function to a user having a mobile unit that stores user data of the user, the system comprising:
a controllable device configured to:
receive the user data from the mobile unit via a background system communicatively coupled between the mobile unit and the controllable device, and
provide the at least one user-specific function to the user individually as a function of the transmitted user data of the user.

15. The media playback device having an apparatus as claimed in claim 1, wherein the media playback device individually plays back media contents, in particular audio or video sequences, as a function of the user data transmitted for the user by the background system to the media playback device.

16. A media playback device configured to playback user-specific media content based on media content target data associated with a particular user and stored in a mobile device of the particular user, the media playback comprising:
a receiving unit configured to receive the media content target data associated with the particular user via a background system communicatively coupled between a mobile unit and the controllable device, and
a processor configured to compare the received media content target data associated with the particular user with available media contents provided by at least one content provider on different media transmission channels, and select particular media contents for playback based on the results of the comparison.

17. (canceled)

18. A method for providing at least one user-individual function to a user, comprising:
transmitting user data of a user from a mobile unit associated with the user to a background system,
transmitting the user data from the background system to a controllable device,
the controllable device providing at least one user-specific function to the user individually as a function of the received user data of the user.

19. The method of claim 18, wherein the user data includes user status data of the user and functional target data that can be adjusted by the user with respect to the functions provided by the controllable device to the user.

20. The method of claim 19, wherein the user-individual function provides the device in a user-specific manner that is specified in the functional target data.
